(19) United States
(12) Patent Application Publication
(10) Pub. No.: US 2008/0256867 A1
(43) Pub. Date: Oct. 23, 2008

(54) Window regulator having an attitude adjustment mechanism

(76) Inventors: Florian Meyer, Greenville, SC (US); Andreas Bauer, Greenville, SC (US)

Correspondence Address: Timothy J. Klima;Harbin King & Klima, 500 Ninth Street SE, Washington, DC, 20003, US

(21) Appl. No.: 11/785,584

(22) Filed: Apr. 18, 2007

(51) Int. Cl. E05D 13/00

(52) U.S. Cl. 49/322

(57) ABSTRACT

A window regulator includes at least one rail and at least one movable carriage for attachment to a movable window, each movable carriage movably attached to a respective rail for movement along the rail. A driving mechanism is attached to the movable carriage for moving the movable carriage along the rail in a regulated manner. An adjustable stop is attached to the rail, the adjustable stop positioned to engage a portion of the respective movable carriage/window assembly attached to that rail, to prevent further movement of the movable carriage/window assembly in one direction.

The present invention relates to a window regulator, generally of the type used to raise and lower a window in an automobile, and more specifically, the present invention relates to an adjustment mechanism for such a window regulator.

A conventional window regulating mechanism for an automobile utilizes one or two rails for guiding movement of the window. One or two moving carriages are attached, respectively, to a front portion of the window and to a rear portion of the window. Each of the moving carriages is attached to a cable driving mechanism and each moving carriage is inserted into a respective one of the rails such that each carriage (and the window to which it is attached) can be driven upward and downward in the rails by the cable driving mechanism. The cable driving mechanism can be powered by an electrical (or other) motor, or manually.

Each of the rails is individually mountable to a door structure of the automobile and the attachment mechanism used to attach each rail can also allow for a certain range of height adjustment of the rail with respect to the door. It is desirable that the window can be adjusted as to position when installed in the door, via the rails. One adjustment that is especially important is to be able to adjust the attitude of the window when at or near an open bottomed or closed position. Such window attitude adjustment can be difficult, time consuming and can affect other adjustments of the window if done while trying to reposition one or both of the rails with respect to the door.

Japanese patent application 11165833, filed Nov. 6, 1999, entitled “Window Panel Adjusting Device and Attitude Adjusting Method of Window Regulator”, discloses a conventional type of automobile window regulating mechanism as described above that further includes a window attitude adjustment mechanism. The window regulator 2 includes a pair of rails 4 and 5. A lower edge 3e of a window panel 3 is supported on a respective pair of moving bodies 6 and 7 that move upward and downward in their respective rails 4 and 5. A driving device 13 connects to the moving bodies 6 and 7 via cables 10 and 11 to drive the moving bodies in the desired direction. At least one of the moving bodies includes a boss for supporting the underside 3e of the window 3. A flexible stopper (or bumper) 15 can optionally be installed between the boss and the underside 3e of the window 3 to alter the positioning of the window 3 with respect to that moving body, and thus, the attitude of the window 3 with respect to the rails and door.

Once an appropriate stopper is positioned between the moving body and the window, such position of the window with respect to the moving body is maintained. That is, the attitude of the window derived from placement of the stopper 15 under the window 3 is generally maintained throughout the movement range of the window.

It is desirable to provide a window regulating mechanism that can be adjusted to change an attitude or max travel of a window at only a portion of the travel range of the window, and preferably, only at or near the opened, bottomed position or the closed position.

The present invention is a window regulator, having one rail, or a pair of spaced apart rails, and a movable carriage for each rail for attachment to a movable window, each movable carriage movably attached to a respective rail for movement along the rail. A driving mechanism is attached to the movable carriages for moving the movable carriages along the rails in a regulated manner. An adjustable stop is attached to at least one of the rails, the adjustable stop being positioned to engage a portion of the respective movable carriage/window assembly attached to that rail, to prevent further movement of the movable carriage/window portion in one direction.

In a preferred embodiment, the adjustable stop includes a threaded portion and at least one of the rails includes a threaded portion for receiving the threaded portion of the adjustable stop such that a position of the adjustable stop with respect to that rail is adjustable by rotation of the adjustable stop in the threaded portion of the rail, thereby altering a position at which the movable carriage/window portion engages the adjustable stop.

The invention will be described in more detail with respect to the attached figures, where like reference numerals indicate like components.

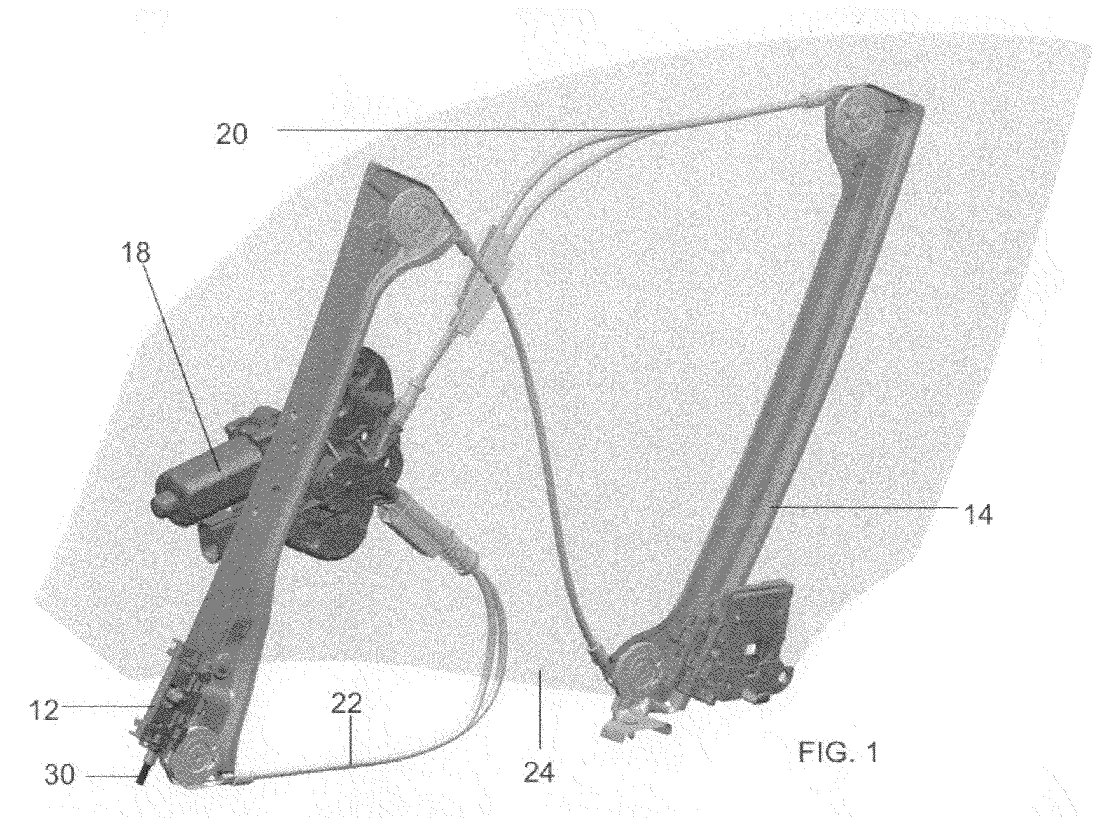

FIG. 1 is a perspective view of an overall window regulator of the present invention.

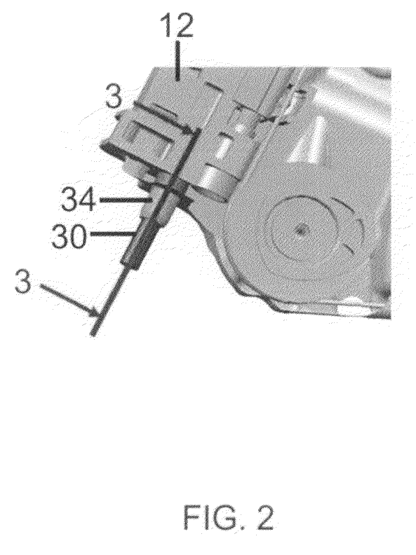

FIG. 2 is a partial close-up view of the window regulator of FIG. 1 showing a detail view of an adjustable stop of the present invention.

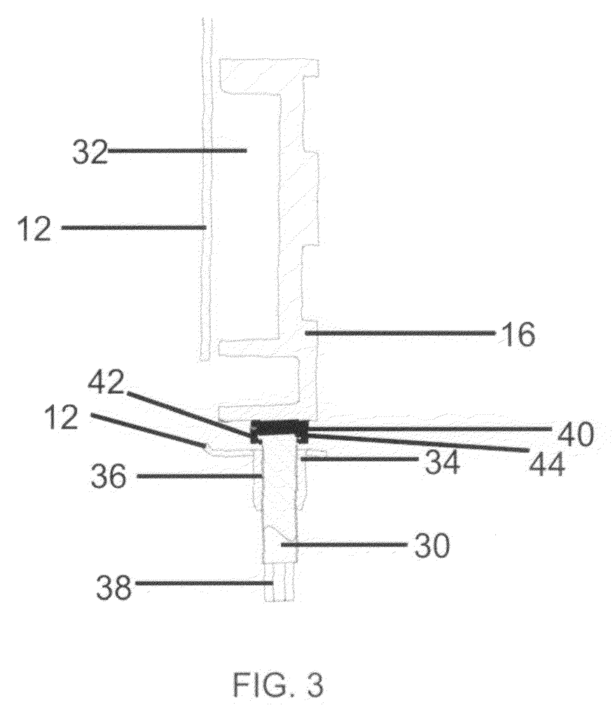

FIG. 3 is a partial sectional view of the window regulator and adjustable stop of the present invention taken along section line 3-3 of FIG. 2.

An entire window regulator 10 can be seen in FIG. 1. It includes a pair of rails 12 and 14. A pair of movable carriages are positioned in the rails 12 and 14, respectively (movable carriage 16 is visible in FIG. 3). A drive mechanism 18 drives the movable carriages via cables 20 and 22. A window 24 is attached to the movable carriages and can be opened and closed by moving the movable carriages in the rails. This much of the window regulator 10 is conventional. The present invention is also applicable to conventional regulators having just one rail.

An adjustable stop 30 is shown in FIGS. 2 and 3. Rail 12 has a channel 32 in which the movable carriage 16 is positioned for drivable movement between fully closed and fully open positions. Rail 12 also has a threaded portion 34 positioned at a bottom portion thereof. This threaded portion can be directly formed on the rail or can also be a threaded insert of some type that is attached to the rail. The adjustable stop 30 is generally in the form of an elongated screw and includes a threaded portion 36 for threadingly engaging threaded portion 34. The threaded portion 34 is positioned such that the adjustable stop 30 threaded therein will engage a bottom facing surface of the movable carriage 16 when the movable carriage 16 is at or near its fully open, or bottomed, position, and the adjustable stop 30 is threaded far enough into the threaded portion 34. Alternatively, but less preferable than this embodiment, the threaded bore 34 can be positioned such that the adjustable stop 30 threaded therein will engage a bottom facing surface of the window 24, or some other portion of the movable carriage/window assembly, when the window 24 is at or near its fully open, or bottomed, position. Then, by adjusting the position of the adjustable stop 30 in the threaded bore 34, the stopping position of the movable carriage/window portion can be adjusted to a desired position. Alternatively, the adjustable stop can be positioned at an upper portion of the rail to contact a portion of the movable carriage/window assembly and limit upper movement thereof.

Use of the threaded engagement between the adjustable stop and the rail allows for an infinitely variable adjustable stop (within the range of the threaded engagement) that is simply and quickly adjustable to provide a desired stop position for the window, and thus, a desired attitude of the window in or near the fully opened bottomed (or closed) position. The adjustable stop is easily readjusted later, should such readjustment be necessary, without need for any additional components (other than hand tools). The adjustable stop is simple and cost-effective to manufacture and use. In an alternative embodiment, the adjustable stop can be attached to the movable carriage and positioned for stopping engagement with a portion of the rail, although this is a much less preferred and practical embodiment.

The adjustable stop 30 includes an exterior facing formed portion 38 for engagement with a driving tool to rotate and adjust the adjustable stop 30. The formed portion can be conventionally shaped for engagement with conventional driving tools, and can be shaped, for instance, in a hex shape, a hex socket, a Torx® shape, a slotted shape, a Phillips shape, or other known shapes.

In a preferred embodiment, a flexible bumper 40 is positioned between the adjustable stop 30 and the movable carriage 16/window portion 24 to cushion an impact between the movable carriage 16/window portion 24 and the adjustable stop 30. The flexible bumper 40 is preferably made from a polymeric material and is molded to attach to the adjustable stop 30, having a shape configured to engage and grip a portion of the adjustable stop. See FIG. 3. There, the flexible bumper 40 is shown as having an internal lipped bore 42 for engaging a lipped portion 44 of adjustable stop 30. The flexible bumper can also be attached to at least one of the movable carriage 16 and the window portion 24. Other attachments mechanisms can also be used including glue and threaded fasteners.

In a preferred embodiment, a locking mechanism is provided for engaging the adjustable stop 30 and preventing unwanted movement of the adjustable stop 30 once adjusted. The locking mechanism can be a threaded nut for engaging both the threaded portion 36 of the adjustable stop 30 and the rail 12 to lock the adjustable stop 30 with respect to the rail 12. The locking mechanism can also be a friction fit between the threaded portion 36 of the adjustable stop and the threaded bore 34 of the rail 12, and can include a mechanical interference fit, a locking glue and/or a polymeric insert or coating engaging between the respective threaded portions.

An adjustable stop 30 can be attached to each rail 12, 14, for engaging the respective movable carriage/window portion attached to that rail and preventing further movement of the movable carriage/window portion in ohe direction. Alternatively, only a single adjustable stop 30 is utilized, attached to a single rail. The adjustable stop 30 engages the respective movable carriage/window portion only at or near a lower (or upper) portion of its travel.

The rails and movable carriages can be formed of metal, appropriate plastics, or other materials. The adjustable stop is preferably metal, although it can also be made of an appropriate plastic or other material.

The different aspects of the invention can be combined in different combinations than shown to create new embodiments of the present invention.

What is claimed is:

1. A window regulator, comprising:
at least one rail;
at least one movable carriage for attachment to a movable window, each movable carriage movably attached to a respective rail for movement along the rail;
a driving mechanism attached to the movable carriage for moving the movable carriage along the rail in a regulated manner;
an adjustable stop attached to the rail, the adjustable stop positioned to engage a portion of the respective movable carriage/window assembly attached to that rail, to prevent further movement of the movable carriage/window portion in one direction.

2. A window regulator as in claim 1, wherein the adjustable stop includes a threaded portion and the rail includes a threaded portion for receiving the threaded portion of the adjustable stop such that a position of the adjustable stop with respect to that rail is adjustable by rotation of the adjustable stop in the threaded portion, thereby altering a position at which the movable carriage/window assembly portion engages the adjustable stop.

3. A window regulator as in claim 2, and further including a flexible bumper positioned between the adjustable stop and the movable carriage/window assembly portion to cushion an impact between the movable carriage/window assembly portion and the adjustable stop.

4. A window regulator as in claim 3, wherein the flexible bumper is molded from a polymeric material and is attached to the adjustable stop, having a shape configured to engage and grip a portion of the adjustable stop.

5. A window regulator as in claim 4, and further comprising a locking mechanism for engaging the adjustable stop and preventing unwanted movement of the adjustable stop once adjusted.

6. A window regulator as in claim 5, wherein the locking mechanism is a threaded nut for engaging both the threaded surface of the adjustable stop and the rail to lock the adjustable stop with respect to the rail.

7. A window regulator as in claim 5, wherein the locking mechanism is a friction fit between the threaded surface of the adjustable stop and the threaded bore of the rail.

8. A window regulator as in claim 5, wherein the adjustable stop includes a formed end for engagement with a tool used to rotate the adjustable stop, the formed end positioned opposite an end engageable with the movable carriage/window portion.

9. A window regulator as in claim 8, wherein the formed end of the adjustable stop extends beyond an exterior surface of the rail.

10. A window regulator as in claim 5, and further comprising an adjustable stop attached to each rail, for engaging the respective movable carriage/window assembly portion attached to that rail and preventing further movement of the movable carriage/window assembly in one direction.

11. A window regulator as in claim 5, wherein only a single adjustable stop attached to a single rail is utilized.

12. A window regulator as in claim 5, wherein the adjustable stop engages the respective movable carriage/window assembly portion only at a bottom portion of its travel.

13. A window regulator as in claim 1, and further including a flexible bumper attached to the adjustable stop and positioned to engage the movable carriage/window assembly portion and cushion an impact between the movable carriage/window assembly portion and the adjustable stop.

14. A window regulator as in claim 13, wherein the flexible bumper is molded from a polymeric material and has a shape configured to engage and grip the adjustable stop.

15. A window regulator as in claim 1, and further comprising a locking mechanism for engaging the adjustable stop and preventing unwanted movement of the adjustable stop once adjusted.

16. A window regulator as in claim 15, wherein the locking mechanism is a threaded nut for engaging both the threaded surface of the adjustable stop and the rail to lock the adjustable stop with respect to the rail.

17. A window regulator as in claim 15, wherein the locking mechanism is a friction fit between the threaded surface of the adjustable stop and the threaded bore of the rail.

18. A window regulator as in claim 1, wherein the adjustable stop includes a formed end for engagement with a tool used to rotate the adjustable stop, the formed end positioned opposite an end engageable with the movable carriage/window portion.

19. A window regulator as in claim 18, wherein the formed end of the adjustable stop extends beyond an exterior surface of the rail.

20. A window regulator as in claim 1, and further comprising an adjustable stop attached to each rail, for engaging the respective movable carriage/window assembly portion attached to that rail and preventing further movement of the movable carriage/window assembly in one direction.

21. A window regulator as in claim 1, wherein only a single adjustable stop attached to a single rail is utilized.

22. A window regulator as in claim 1, wherein the adjustable stop engages the respective movable carriage/window assembly portion only at a lower portion of its travel.

23. A window regulator as in claim 3, wherein the flexible bumper is molded from a polymeric material and is attached to the movable carriage/window assembly portion.
